(19) United States
(12) Patent Application Publication
(10) Pub. No.: US 2023/0383450 A1
(43) Pub. Date: Nov. 30, 2023

(54) Fabric Processing Device

(71) Applicant: SEIKO EPSON CORPORATION, Tokyo (JP)

(72) Inventors: Hirokazu SEKINO, Chino (JP); Osamu KATSUDA, Matsumoto (JP); Takeshi SETO, Shiojiri (JP)

(21) Appl. No.: 18/323,684

(22) Filed: May 25, 2023

(30) Foreign Application Priority Data
May 26, 2022 (JP) 2022-085958

(51) Int. Cl. D06B 1/02; D06B 23/04; D06B 23/20

(52) U.S. Cl. CPC D06B 1/02; D06B 23/04; D06B 23/20

(57) ABSTRACT

A fabric processing device includes a transport unit configured to transport a fabric in a transport direction; a support unit configured to support the fabric; and a liquid ejecting unit configured to eject a liquid onto the fabric supported by the support unit. The liquid ejecting unit is configured to eject the liquid in a continuous flow at an ejecting speed of 30 m/s or more, and the liquid ejected as the continuous flow is caused to collide with the fabric in a state of being liquid droplets to process the fabric. The fabric processing device having such a configuration can effectively improve texture of the fabric.

The present application is based on, and claims priority from JP Application Serial Number 2022-085958, filed May 26, 2022, the disclosure of which is hereby incorporated by reference herein in its entirety.

### BACKGROUND

### 1. Technical Field

The present disclosure relates to a fabric processing device.

### 2. Related Art

In the related art, various types of processing have been performed on a fabric in order to improve texture of the fabric. For example, JPH07-133578A discloses an air flow type texture processing method for adjusting texture such as flexibility by using an air flow on a fabric and the like subjected to textile printing processing. In the air flow type texture processing method disclosed in JPH07-133578A, water or steam is sprayed and supplied into an air flow, the air flow is ejected from a processed fluid ejecting unit onto a fabric to impart a wetting effect to the fabric, and then a dry air flow is applied to the fabric to dry the fabric. In the air flow type texture processing method disclosed in JPH07-133578A, an impact is repeatedly applied by the air flow, and thus fine fluff (peaching processing), a drape property, and a slimy feeling are exhibited on a surface of the fabric.

However, in the method for improving the texture of the fabric by applying the air flow to the fabric as described in JPH07-133578A, it is difficult to apply a strong impact to the fabric. Therefore, it is difficult to sufficiently improve the texture of the fabric, and it takes a long time to sufficiently improve the texture of the fabric. As described above, in a method in the related art for improving texture of a fabric, it is difficult to effectively improve the texture of the fabric.

### SUMMARY

A fabric processing device according to the present disclosure includes: a transport unit configured to transport a fabric in a transport direction; a support unit configured to support the fabric; and a liquid ejecting unit configured to eject a liquid onto the fabric supported by the support unit. The liquid ejecting unit is configured to eject the liquid in a continuous flow at an ejecting speed of 30 m/s or more, and the liquid ejected as the continuous flow is caused to collide with the fabric in a state of being liquid droplets to process the fabric.

### BRIEF DESCRIPTION OF THE DRAWINGS

FIG. 1 is a schematic diagram showing a fabric processing device according to a first embodiment.

FIG. 2 is a diagram showing an ejecting direction of the fabric processing device according to the first embodiment.

FIG. 3 is a schematic diagram showing a part of the fabric processing device in FIG. 1.

FIG. 4 is a schematic diagram showing a liquid ejecting unit of the fabric processing device in FIG. 1.

FIG. 5 is a schematic diagram showing a fabric processing device according to a second embodiment.

FIG. 6 is a schematic diagram showing a part of the fabric processing device in FIG. 5.

FIG. 7 is a schematic diagram showing a part of a fabric processing device according to a third embodiment.

FIG. 8 is a schematic diagram from a bottom surface side showing an arrangement of an ejecting port of a liquid ejecting unit of the fabric processing device in FIG. 7.

FIG. 9 is a schematic diagram showing a part of a fabric processing device according to a fourth embodiment.

FIG. 10 is a schematic diagram from a bottom surface side showing an arrangement of an ejecting port of a liquid ejecting unit of the fabric processing device in FIG. 9.

FIG. 11 is a schematic diagram showing a fabric processing device according to a fifth embodiment.

FIG. 12 is a schematic diagram showing a fabric processing device according to a sixth embodiment.

FIG. 13 is a schematic diagram showing a fabric processing device according to a seventh embodiment.

FIG. 14 is a schematic diagram showing a part of a fabric processing device according to an eighth embodiment.

FIG. 15 is a schematic diagram from a bottom surface side showing an arrangement of an ejecting port of a liquid ejecting unit of the fabric processing device in FIG. 14.

### DESCRIPTION OF EXEMPLARY EMBODIMENTS

First, the present disclosure will be schematically described.

A fabric processing device according to a first aspect of the present disclosure for solving the above problems includes: a transport unit configured to transport a fabric in a transport direction; a support unit configured to support the fabric; and a liquid ejecting unit configured to eject a liquid onto the fabric supported by the support unit, in which the liquid ejecting unit is configured to eject the liquid in a continuous flow at an ejecting speed of 30 m/s or more, and the liquid ejected as the continuous flow is caused to collide with the fabric in a state of being liquid droplets to process the fabric.

According to this aspect, the liquid ejecting unit is configured to eject the liquid in the continuous flow at the ejecting speed of 30 m/s or more, and the liquid ejected as the continuous flow is caused to collide with the fabric in the state of being the liquid droplets to process the fabric. That is, the processing of the fabric is performed by a method capable of applying, to the fabric, a strong impact by which the liquid ejected as the continuous flow collides with the fabric in the state of being the liquid droplets at the high ejecting speed of 30 m/s or more. Therefore, texture of the fabric can be effectively improved. When the ejecting speed is less than 30 m/s, it may be difficult to apply the strong impact to the fabric.

The fabric processing device according to a second aspect of the present disclosure is directed to the first aspect, in which the liquid ejecting unit is configured to eject the liquid in the continuous flow at an ejecting speed of 500 m/s or less.

According to this aspect, the liquid is ejected in the continuous flow at the ejecting speed of 500 m/s or less. When the ejecting speed exceeds 500 m/s, the fabric may be damaged, but the texture of the fabric can be effectively improved without damaging the fabric.

The fabric processing device according to a third aspect of the present disclosure is directed to the first or second aspect, in which the support unit has a support surface that supports the fabric, and the liquid ejecting unit is disposed at a position facing the support surface.

According to this aspect, the support unit has the support surface that supports the fabric, and the liquid ejecting unit is disposed at the position facing the support surface. Therefore, a configuration capable of effectively improving the texture of the fabric can be easily formed.

The fabric processing device according to a fourth aspect of the present disclosure is directed to the third aspect, in which the liquid ejecting unit is configured to eject the liquid in an ejecting direction forming an angle of 0° or more and 45° or less with respect to a normal line of the support surface.

According to this aspect, the liquid ejecting unit is configured to eject the liquid in the ejecting direction forming the angle of 0° or more and 45° or less with respect to the normal line of the support surface. With such a configuration, a particularly strong impact can be applied to the fabric, and the texture of the fabric can be particularly effectively improved.

The fabric processing device according to a fifth aspect of the present disclosure is directed to the fourth aspect, in which the support surface is a convex curved surface protruding toward a liquid ejecting unit side.

According to this aspect, the support surface is the convex curved surface protruding toward the liquid ejecting unit side. With such a configuration, the fabric can be firmly supported by applying tension to the convex curved surface, and the liquid can be suitably ejected onto the fabric.

The fabric processing device according to a sixth aspect of the present disclosure is directed to the fourth aspect, in which the support surface is a flat surface.

According to this aspect, the support surface is the flat surface. With such a configuration, a wide range of the fabric can be supported by the support surface, and the liquid can be suitably ejected over the wide range of the fabric.

The fabric processing device according to a seventh aspect of the present disclosure is directed to the sixth aspect, in which the support surface has a normal line of the flat surface forming an angle of 0° or more and 45° or less with respect to a horizontal plane.

According to this aspect, the support surface has the normal line of the flat surface forming the angle of 0° or more and 45° or less with respect to the horizontal plane. With such a configuration, it is possible to prevent the liquid ejected from the liquid ejecting unit from dripping onto the liquid ejecting unit, and it is also possible to prevent the liquid rebounding from the support surface from adhering to the liquid ejecting unit, and thus it is possible to prevent the occurrence of ejecting failure in the liquid ejecting unit.

The fabric processing device according to an eighth aspect of the present disclosure is directed to the first or second aspect, in which the liquid ejecting unit includes a nozzle having at least one ejecting port configured to eject the liquid, a liquid transport unit configured to transport the liquid to the ejecting port, and a pressurizing unit configured to pressurize the liquid in the liquid transport unit.

According to this aspect, the liquid ejecting unit includes the nozzle having at least one ejecting port configured to eject the liquid, the liquid transport unit configured to transport the liquid to the ejecting port, and the pressurizing unit configured to pressurize the liquid in the liquid transport unit. With such a configuration, it is possible to suitably form the liquid ejecting unit which ejects the liquid as the continuous flow, and in which the liquid ejected as the continuous flow collides with the fabric in the state of being the liquid droplets.

The fabric processing device according to a ninth aspect of the present disclosure is directed to the eighth aspect, in which the ejecting port has a diameter of 0.005 mm or more and 0.12 mm or less.

According to this aspect, the ejecting port has the diameter of 0.005 mm or more and 0.12 mm or less. By setting the diameter of the ejecting port as described above, it is possible to suitably eject the liquid as a continuous flow and cause the liquid to collide with the fabric in the state of being the liquid droplets.

The fabric processing device according to a tenth aspect of the present disclosure is directed to the eighth aspect, in which the pressurizing unit has a pressurizing pressure of 0.5 MPa or more and 150 MPa or less.

According to this aspect, the pressurizing unit has the pressurizing pressure of 0.5 MPa or more and 150 MPa or less. With such a pressurizing pressure of the pressurizing unit, the texture of the fabric can be effectively improved without damaging the fabric.

The fabric processing device according to an eleventh aspect of the present disclosure is directed to the first or second aspect, and further includes: a control unit configured to control an ejecting amount of the liquid ejected from the liquid ejecting unit.

According to this aspect, the fabric processing device includes the control unit configured to control the ejecting amount of the liquid ejected from the liquid ejecting unit. Therefore, the liquid can be automatically ejected from the liquid ejecting unit in a preferable ejecting amount.

The fabric processing device according to a twelfth aspect of the present disclosure is directed to the first or second aspect, in which the transport unit includes a driving roller configured to transport the fabric in the transport direction by rotating.

According to this aspect, the transport unit includes the driving roller configured to transport the fabric in the transport direction by rotating. With such a configuration, it is possible to suitably form the transport unit that transports the fabric in the transport direction.

The fabric processing device according to a thirteenth aspect of the present disclosure is directed to the first or second aspect, in which the support unit has a suction hole, and the fabric processing device further includes a suction unit configured to perform suction from the suction hole.

According to this aspect, the support unit has the suction hole, and the fabric processing device includes the suction unit configured to perform suction from the suction hole. Therefore, it is possible to reliably support the fabric on the support unit by suctioning the fabric through the suction hole, and it is possible to prevent a situation in which the liquid is accumulated on the fabric and a strong impact cannot be applied to the fabric when the liquid is suctioned through the suction hole.

### First Embodiment

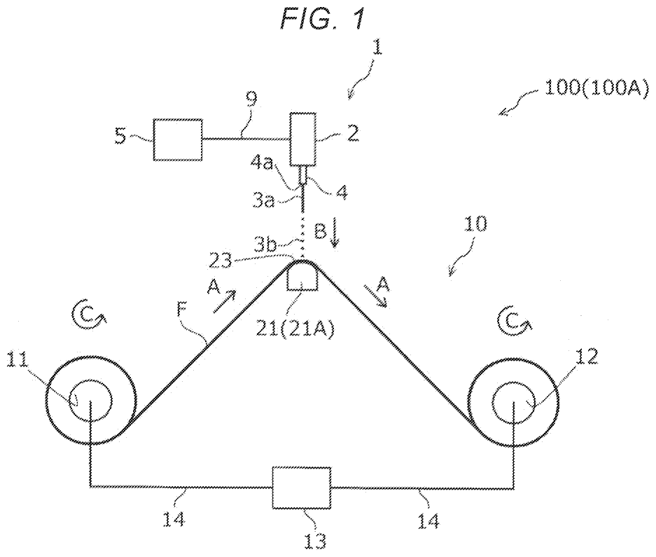

Hereinafter, an embodiment of the present disclosure will be described with reference to accompanying drawings. First, an outline of a fabric processing device 100A according to a first embodiment of the present disclosure as a fabric processing device 100 will be described with reference to FIG. 1. The fabric processing device 100A shown in FIG. 1 includes a transport unit 10 that transports a fabric F in a transport direction A, a support unit 21 that supports the fabric F, and a liquid ejecting unit 1 that ejects a liquid 3 onto the fabric F supported by the support unit 21.

The transport unit 10 includes a setting shaft 11 on which the rolled fabric F can be set, and a winding shaft 12 on which the fabric F transported in the transport direction A can be wound in a roll shape. The setting shaft 11 and the winding shaft 12 are coupled to a transport control unit 13 via a cable 14, and are rotatable in a rotation direction C under the control of the transport control unit 13. The transport control unit 13 can apply desired tension to the fabric F transported in the transport direction A from the setting shaft 11 toward the winding shaft 12 by controlling a rotation speed of the winding shaft 12 to be faster than a rotation speed of the setting shaft 11 when the fabric F is transported.

From another point of view, the transport unit 10 of the fabric processing device 100A according to the embodiment includes the setting shaft 11 and the winding shaft 12 as a driving roller that transports the fabric F in the transport direction A by rotating. With such a configuration, it is possible to suitably form the transport unit 10 that transports the fabric F in the transport direction A.

A support unit 21A of the embodiment serving as the support unit 21 has a support surface 23 that supports the fabric F, and the support surface 23 is a convex curved surface that protrudes toward a liquid ejecting unit 1 side. With such a configuration, the fabric F can be firmly supported without a gap by applying tension to the convex curved surface, and the liquid 3 can be suitably ejected onto the fabric F. “The support surface 23 is a convex curved surface that protrudes toward the liquid ejecting unit 1 side” means, in detail, “a contact point between the support surface 23 and a straight line of the support surface 23 extending from the liquid ejecting unit 1 in an ejecting direction B and a peripheral region thereof form a convex curved surface that protrudes toward the liquid ejecting unit 1 side”. Accordingly, a portion other than the contact point and the peripheral region thereof may not be a convex curved surface.

Here, the support unit 21A of the embodiment is made of stainless steel. When the support unit 21 is made of a hard material that is resistant to rust, such as stainless steel, corrosion or deformation caused by the liquid 3 ejected from the liquid ejecting unit 1 is prevented. By preventing corrosion and deformation of the support unit 21, it is possible to prevent damping of an impact pressure when the liquid 3 ejected from the liquid ejecting unit 1 lands on the fabric F, and it is possible to efficiently apply an impact for improving the texture to the fabric F.

The liquid ejecting unit 1 is disposed at a position facing the support surface 23. Therefore, a configuration capable of effectively improving the texture of the fabric F is easily formed. With such a configuration, the liquid 3 can be ejected from the liquid ejecting unit 1 substantially perpendicularly to the support surface 23. By ejecting the liquid 3 from the liquid ejecting unit 1 perpendicularly to the support surface 23, it is possible to efficiently apply an impact for improving the texture to the fabric F.

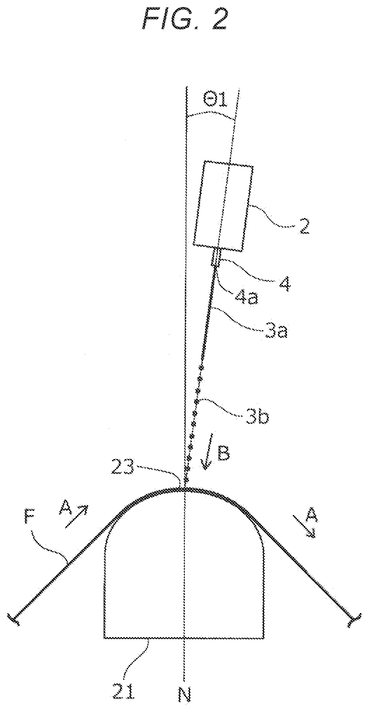

Here, the ejecting direction B of the liquid 3 with respect to the support surface 23 will be described with reference to FIG. 2. As described above, in the fabric processing device 100A according to the embodiment, the ejecting direction B of the liquid 3 is substantially perpendicular to the support surface 23. Here, it is preferable that the liquid ejecting unit 1 ejects the liquid 3 in the ejecting direction B that forms an angle of 0° or more and 45° or less with respect to a normal line N of the support surface 23. As described with reference to FIG. 2, it is preferable that the liquid ejecting unit 1 is disposed with respect to the support surface 23 such that an angle θ1 formed by the ejecting direction B with respect to the normal line N is an angle of 0° or more and 45° or less. This is because, with such a configuration, a particularly strong impact can be applied to the fabric F, and the texture of the fabric F can be particularly effectively improved.

Experimental results obtained when the ejecting direction B of the liquid 3 with respect to the support surface 23 is changed are shown below. The fabric F having a length of 50 mm in both the vertical and horizontal directions is wound around a columnar stainless steel bar having a diameter of 30 mm, and water as the liquid 3 is ejected from the liquid ejecting unit 1 according to the embodiment while changing the ejecting direction B, thereby confirming the difference in texture of the fabric F. Since the difference in texture of the fabric F is proportional to an impact pressure applied to the fabric F, the difference in texture of the fabric F is determined by the degree of color loss of the fabric F using the fabric F in which the degree of color loss increases as the impact pressure increases. Specifically, the ejecting direction B is evaluated at positions where the angle θ1 is 0°, 8°, 15°, 24°, 32°, 42°, 53°, and 69°. As a result, the degree of color loss is higher from 0° to 42°, slightly low at 53°, and low at 69°. As a result of further evaluation, it is found that it is preferable to dispose the liquid ejecting unit 1 with respect to the support surface 23 such that the angle θ1 is an angle of 0° or more and 45° or less.

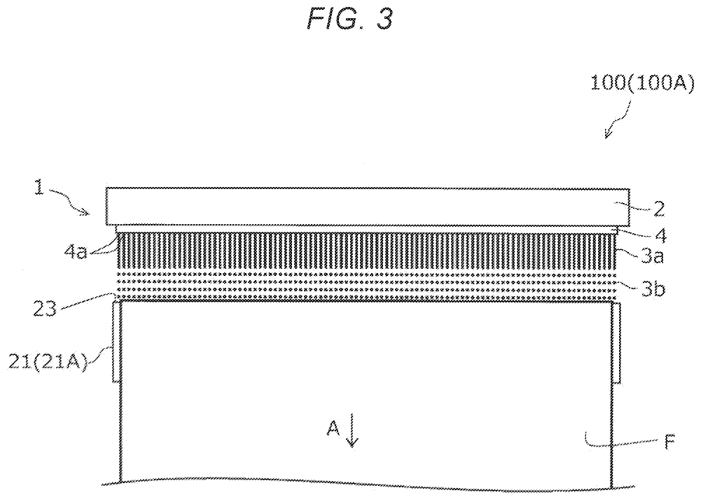

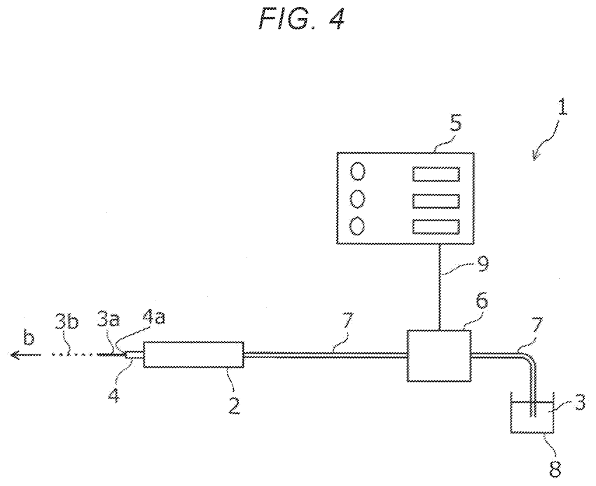

Next, the configuration of the liquid ejecting unit 1 will be further described in detail with reference to FIGS. 3 and 4. As shown in FIG. 3, the liquid ejecting unit 1 according to the embodiment includes a nozzle 4 in which a plurality of ejecting ports 4a of the liquid 3 are provided in a line shape over the entire width direction that is a direction intersecting the transport direction A of the fabric F. The nozzle 4 is provided at a front end of a head unit 2. In the nozzle 4, a reinforcement plate (not shown) having a hole portion having a diameter sufficiently larger than that of the ejecting port 4a is formed corresponding to a position of the ejecting port 4a over the entire width direction, thereby preventing deformation of the nozzle 4. However, the configuration of the head unit 2 is not particularly limited, and instead of a line head as in the embodiment, for example, the head unit 2 may be provided as a carriage capable of reciprocating in the width direction, and the liquid 3 may be ejected to the entire width direction of the fabric F by reciprocating the head unit 2 in the width direction.

As shown in FIG. 4, the liquid ejecting unit 1 according to the embodiment includes a liquid transport unit 7 which is a tube for transporting the liquid 3 to the ejecting ports 4a, and a pressurizing unit 6 for pressurizing the liquid 3 in the liquid transport unit 7, in addition to the head unit 2 in which the nozzle 4 having at least one ejecting port 4a for ejecting the liquid 3 is provided. With such a configuration, it is possible to suitably form the liquid ejecting unit 1 which ejects the liquid 3 as a continuous flow 3a, and in which the liquid 3 ejected as the continuous flow 3a collides with the fabric F in the state of being liquid droplets 3b.

As described above, the liquid ejecting unit 1 according to the embodiment is a liquid ejecting device that causes the liquid droplets 3b to collide with the fabric F as an object in a state where the continuous flow 3a of the liquid 3 ejected continuously in the ejecting direction B from the plurality of ejecting ports 4a provided in the head unit 2 is formed into the liquid droplets 3b. As the liquid 3, water can be preferably used, and a water solution containing water as a solvent and various solvents and additives, a volatile organic solvent, and the like can be used without particular limitation.

Here, the liquid transport unit 7 as a liquid sending flow path coupling a liquid storage unit 8 to the head unit 2 is formed by using a soft resin material and the like, and thus it is possible to improve handling properties. The pressurizing unit 6 is driven under control of a control unit 5 coupled by a control signal line 9, and sends the liquid 3 at a predetermined pressure or a predetermined flow rate. The pressure or the flow rate can be freely changed by a user inputting an instruction to the control unit 5. In other words, the control unit 5 can control the ejecting amount of the liquid 3 ejected from the liquid ejecting unit 1. Therefore, the liquid 3 can be automatically ejected from the liquid ejecting unit 1 in a preferable ejecting amount.

Hereinafter, preferable ejecting conditions for effectively improving the texture of the fabric will be described in detail. In the following evaluation, the liquid 3 was ejected from the liquid ejecting unit 1 onto the fabric F having a vertical length of 50 mm and a horizontal length of 25 mm using the fabric processing device 100A according to the embodiment, and thereafter, one end portion of the fabric F in a longitudinal direction was set in a horizontal state with a resin plate interposed therebetween by 5 mm, and the change in texture of the fabric F was evaluated based on a degree of mm of a dripping length d at a position 30 mm away from the resin plate in a horizontal direction at that time. The larger the dripping length d, the larger the change in texture, that is, GOOD. Results are shown in the following Table 1.

TABLE 1

| Ejecting speed (m/s) | d (mm) | Evaluation result |
|---|---|---|
| Without ejection | 6 | — |
| 20 | 7 | N.G. |
| 30 | 10 | GOOD |
| 44 | 12 | GOOD |

As shown in Table 1, in the fabric F onto which the liquid 3 was ejected at an ejecting speed of 20 m/s, for the fabric F in an initial state in which the liquid 3 was not ejected, there was no significant difference in the dripping length d, and there was little change in the texture of the fabric F. On the other hand, in the fabric F onto which the liquid 3 was ejected at ejecting speeds of 30 m/s and 44 m/s, the dripping length d was clearly longer than that of the fabric F in the initial state, and the change in the texture was remarkable.

As described above, in the fabric processing device 100A according to the embodiment, the liquid 3 ejected as the continuous flow 3a collides with the fabric F in the state of being the liquid droplets 3b, and it is preferable that the ejecting speed when ejecting the liquid 3 is 30 m/s or more in order to change the texture of the fabric F. That is, it is preferable that the fabric is processed by a method capable of applying, to the fabric F, a strong impact by which the liquid 3 ejected as the continuous flow 3a collides with the fabric F in the state of being the liquid droplets 3b at the high ejecting speed of 30 m/s or more in order to change the texture of the fabric F. This is because when the ejecting speed is less than 30 m/s, it may be difficult to apply a strong impact to the fabric F to change the texture of the fabric F, that is, N.G..

Here, the diameter of the ejecting port 4a in the liquid ejecting unit 1 of the fabric processing device 100A according to the embodiment is 0.12 mm. The following Table 2 shows a correspondence among an ejecting speed, a pressurizing pressure of the pressurizing unit 6, a liquid droplet forming distance which is the distance from the ejecting port 4a until the continuous flow 3a becomes the liquid droplets 3b, and an evaluation result of the change in the texture, when the liquid ejecting unit 1 according to the embodiment in which the diameter of the ejecting port 4a is 0.12 mm is used.

TABLE 2

| Ejecting | Pressurizing | Liquid droplet | Evaluation |
|---|---|---|---|
| speed (m/s) | pressure (MPa) | forming distance (mm) | result |
| 20 | 0.3 | 27 | N.G. |
| 30 | 0.5 | 40 | GOOD |
| 44 | 1.0 | 73 | GOOD |
| 50 | 1.5 | 90 | GOOD |

As described above, by setting the ejecting speed to 30 m/s or more, the texture of the fabric F can be changed. On the other hand, when the pressurizing pressure of the pressurizing unit 6 is larger than 1.5 MPa, for example, when an image and the like is recorded on the fabric F with ink, an image forming surface may be roughened. When the diameter of the ejecting port 4a is 0.12 mm and the pressurizing pressure of the pressurizing unit 6 is 1.5 MPa, the ejecting speed is 50 m/s as shown in Table 2.

The ejecting speed required for changing the texture of the fabric F depends on the diameter of the ejecting port 4a. The smaller the diameter of the ejecting port 4a, the faster the ejecting speed required for changing the texture of the fabric F. For example, when the ejecting port 4a having a diameter of 0.025 mm is used, the pressurizing pressure is 17 MPa and the ejecting speed required for changing the texture is 180 m/s, and when the ejecting port 4a having a diameter of 0.005 mm is used, the pressurizing pressure is 150 MPa and the ejecting speed required for changing the texture is 500 m/s. The following Table 3 shows a relationship between the diameter of the ejecting port 4a, the pressurizing pressure, the ejecting speed, and the flow rate of the liquid 3.

TABLE 3

| Diameter of | Pressurizing | Ejecting | Flow rate |
|---|---|---|---|
| ejecting port (mm) | pressure (MPa) | speed (m/s) | (mL/min) |
| 0.12 | 1.5 | 50 | 25 |
| 0.025 | 17 | 180 | 4.5 |
| 0.005 | 150 | 500 | 0.6 |

From the above, it is preferable that the liquid ejecting unit 1 ejects the liquid 3 as a continuous flow having the ejecting speed of 500 m/s or less. When the ejecting speed exceeds 500 m/s, the fabric may be damaged, and when the ejecting speed is set to 500 m/s or less, the ejecting condition is adjusted, and the texture of the fabric F can be effectively improved without damaging the fabric F. The damage of the fabric F includes damage of the fabric F itself and damage of a printed image and the like formed on the fabric F.

The ejecting port 4a preferably has a diameter of 0.005 mm or more and 0.12 mm or less. This is because, by setting the diameter of the ejecting port 4a as described above, it is possible to suitably eject the liquid 3 as a continuous flow and cause the liquid 3 to collide with the fabric F in the state of being the liquid droplets 3b.

The pressurizing pressure of the pressurizing unit 6 is preferably 0.5 MPa or more and 150 MPa or less. By setting the pressurizing pressure of the pressurizing unit 6 to 0.5 MPa or more and 150 MPa or less, the texture of the fabric F can be effectively improved without damaging the fabric F.

### Second Embodiment

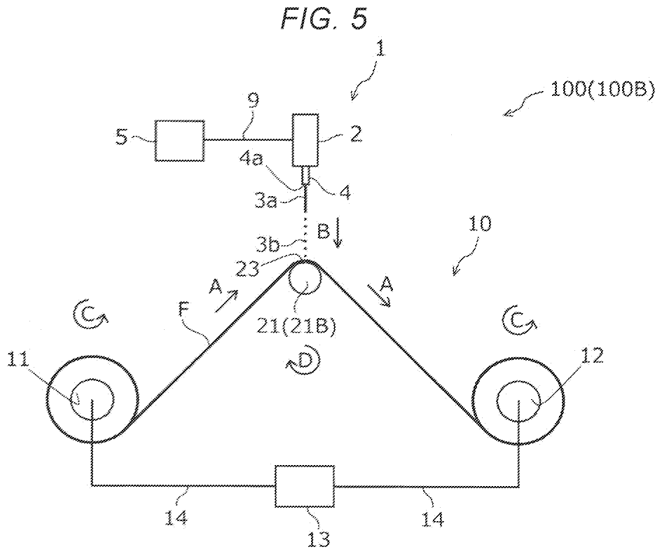

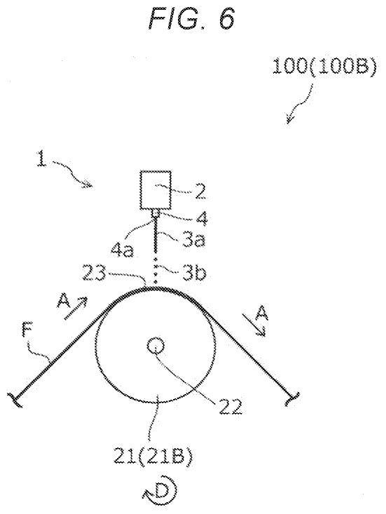

Hereinafter, a fabric processing device 100B according to a second embodiment as the fabric processing device 100 will be described with reference to FIGS. 5 and 6. Among them, FIG. 5 is a diagram corresponding to FIG. 1 of the fabric processing device 100A according to the first embodiment. The fabric processing device 100B according to the embodiment is the same as the fabric processing device 100A according to the first embodiment except for the configuration described below. Therefore, the fabric processing device 100B according to the embodiment has the same features as those of the fabric processing device 100A according to the first embodiment except for the following description. Therefore, in FIGS. 5 and 6, components common to those of the first embodiment are denoted by the same reference numerals, and detailed description thereof will be omitted.

As described above, the fabric processing device 100A according to the first embodiment includes the support unit 21A, as the support unit 21 that supports the fabric F, in which only the support surface 23 is a convex curved surface protruding toward the liquid ejecting unit 1 side. The support unit 21A is immobile. On the other hand, a support unit 21B according to the embodiment has a circular shape in a side view as shown in FIGS. 5 and 6, that is, a columnar shape, and is rotatable in a rotation direction D by following the transport of the fabric F with reference to a rotation shaft 22 shown in FIG. 6 in the same direction as the rotation shafts of the setting shaft 11 and the winding shaft 12. As described above, by forming the support unit 21 as a columnar rotation body, it is possible to reduce friction with the fabric F as compared with the support unit 21 having an immobile configuration, and thus it is possible to prevent the damage of the fabric F due to the friction.

### Third Embodiment

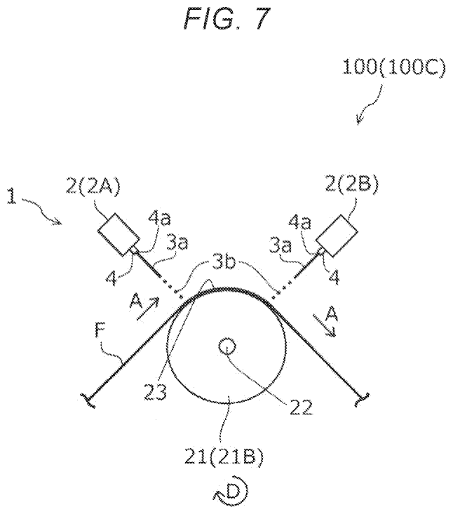

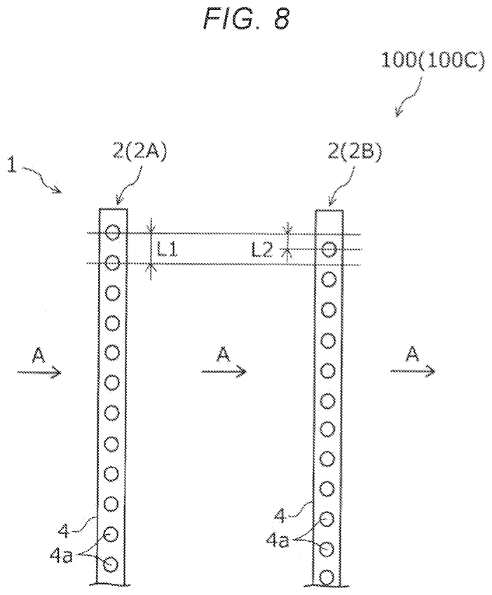

Hereinafter, a fabric processing device 100C according to a third embodiment as the fabric processing device 100 will be described with reference to FIGS. 7 and 8. Among them, FIG. 7 is a diagram corresponding to FIG. 6 of the fabric processing device 100B according to the second embodiment. The fabric processing device 100C according to the embodiment is the same as the fabric processing devices 100 according to the first embodiment and the second embodiment except for the configuration described below. Therefore, the fabric processing device 100C according to the embodiment has the same features as those of the fabric processing devices 100 according to the first embodiment and the second embodiment except for the following description. Therefore, in FIGS. 7 and 8, components common to those of the first embodiment and the second embodiment are denoted by the same reference numerals, and detailed description thereof will be omitted.

As described above, the liquid ejecting unit 1 of the fabric processing device 100 according to each of the first embodiment and the second embodiment has one head unit 2. On the other hand, as shown in FIGS. 7 and 8, the liquid ejecting unit 1 of the fabric processing device 100C according to the embodiment has two head units 2, that is, a first head unit 2A and a second head unit 2B. As shown in FIG. 8, in the width direction intersecting the transport direction A, the positions of the ejecting ports 4a of the first head unit 2A and the positions of the ejecting ports 4a of the second head unit 2B are shifted from each other. Specifically, an ejecting port pitch, which is an interval between the adjacent ejecting ports 4a of each of the first head unit 2A and the second head unit 2B, is a length L1. The position of the ejecting port 4a of the first head unit 2A and the position of the ejecting port 4a of the second head unit 2B are shifted from each other by a length L2, which is half the length L1, in the width direction. With such a configuration, it is possible to narrow the ejecting port pitch of the entire device, and it is possible to particularly suitably improve the texture of the fabric F. By shifting the position of the ejecting port 4a in the transport direction A, there is also an effect of preventing a decrease in the effect of improving the texture of the fabric F due to the liquid 3 accumulating on the fabric F. The length L1 is not particularly limited, and, for example, by setting the length L1 to 1 mm or more, it is possible to prevent interference between the adjacent ejecting ports 4a and to effectively apply an impact to the fabric F.

### Fourth Embodiment

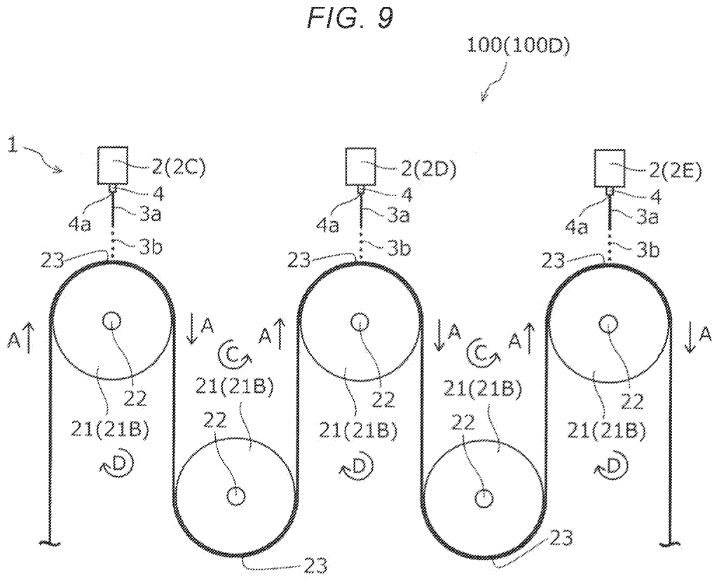

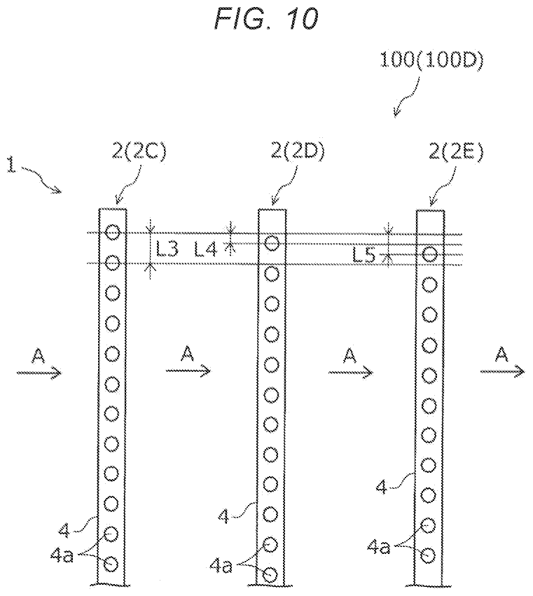

Hereinafter, a fabric processing device 100D according to a fourth embodiment as the fabric processing device 100 will be described with reference to FIGS. 9 and 10. Among them, FIG. 9 is a diagram corresponding to FIG. 7 of the fabric processing device 100C according to the third embodiment. FIG. 10 is a diagram corresponding to FIG. 8 of the fabric processing device 100C according to the third embodiment. The fabric processing device 100D according to the embodiment is the same as the fabric processing devices 100 according to the first embodiment to the third embodiment except for the configuration described below. Therefore, the fabric processing device 100D according to the embodiment has the same features as those of the fabric processing devices 100 according to the first embodiment to the third embodiment except for the following description. Therefore, in FIGS. 9 and 10, components common to those of the first embodiment to the third embodiment are denoted by the same reference numerals, and detailed description thereof will be omitted.

As described above, each of the fabric processing devices 100 according to the first embodiment to the third embodiment includes only one support unit 21. On the other hand, as shown in FIG. 9, the fabric processing device 100D according to the embodiment includes five support units 21B having the same configuration as the support units 21B of the fabric processing devices 100 according to the second embodiment and the third embodiment and are disposed alternately in the vertical direction. On upper sides of the three support units 21B disposed on the upper side, three head units 2, that is, a first head unit 2C, a second head unit 2D, and a third head unit 2E are provided in this order in the transport direction A.

As shown in FIG. 10, in the width direction intersecting the transport direction A, the position of the ejecting port 4a of the first head unit 2C, the position of the ejecting port 4a of the second head unit 2D, and the position of the ejecting port 4a of the third head unit 2E are shifted from each other. Specifically, an ejecting port pitch of each of the first head unit 2C, the second head unit 2D, and the third head unit 2E is a length L3, and the position of the ejecting port 4a of the first head unit 2C and the position of the ejecting port 4a of the second head unit 2D are shifted from each other by a length L4, which is ⅓ of the length L3, in the width direction. The position of the ejecting port 4a of the first head unit 2C and the position of the ejecting port 4a of the third head unit 2E are shifted from each other by a length L5, which is ⅔ of the length L3, in the width direction. With such a configuration, it is possible to narrow the ejecting port pitch of the entire device, and it is possible to particularly suitably improve the texture of the fabric F. By shifting the position of the ejecting port 4a in the transport direction A, there is also an effect of preventing a decrease in the effect of improving the texture of the fabric F due to the liquid 3 accumulating on the fabric F.

### Fifth Embodiment

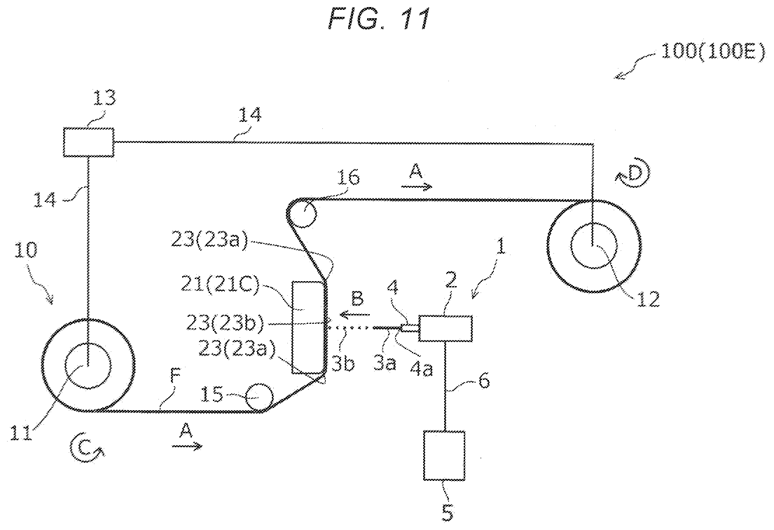

Hereinafter, a fabric processing device 100E according to a fifth embodiment as the fabric processing device 100 will be described with reference to FIG. 11. FIG. 11 is a diagram corresponding to FIG. 1 of the fabric processing device 100A according to the first embodiment. The fabric processing device 100E according to the embodiment is the same as the fabric processing devices 100 according to the first embodiment to the fourth embodiment except for the configuration described below. Therefore, the fabric processing device 100E according to the embodiment has the same features as those of the fabric processing devices 100 according to the first embodiment to the fourth embodiment except for the following description. Therefore, in FIG. 11, components common to those of the first embodiment to the fourth embodiment are denoted by the same reference numerals, and detailed description thereof will be omitted.

As described above, in the fabric processing devices 100 according to the first embodiment to the fourth embodiment, the support surface 23 is formed only by the convex curved surface that protrudes toward the liquid ejecting unit 1 side as the support unit 21 that supports the fabric F. On the other hand, as shown in FIG. 11, a support unit 21C of the fabric processing device 100E according to the embodiment is provided between a driven roller 15 and a driven roller 16, and has convex curved surface portions 23a that protrude toward the liquid ejecting unit 1 side and a flat surface portion 23b as the support surface 23.

In other words, the support surface 23 of the support unit 21C of the fabric processing device 100E according to the embodiment is a flat surface having the flat surface portion 23b. With such a configuration in which the support surface 23 is a flat surface, a wide range of the fabric F can be supported by the support surface 23, and the liquid 3 can be suitably ejected over the wide range of the fabric F. “The support surface 23 is a flat surface” means that, in detail, “a contact point between the support surface 23 and a straight line of the support surface 23 extending from the liquid ejecting unit 1 in the ejecting direction B and a peripheral region thereof are a flat surface”. Therefore, as in the embodiment, the flat surface portion 23b may have the curved surface portions 23a and the like at both end portions of the flat surface portion 23b. By providing the curved surface portions 23a at both end portions of the flat surface portion 23b, it is possible to prevent the fabric F from being damaged by being rubbed against corner portions and the like of the support surface 23. In the embodiment, the ejecting direction B is the horizontal direction, and the ejecting direction B may not be the horizontal direction.

### Sixth Embodiment

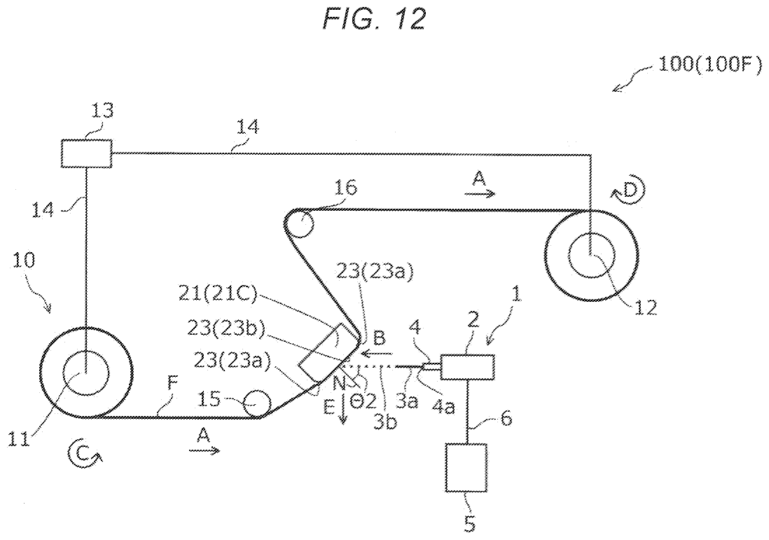

Hereinafter, a fabric processing device 100F according to a sixth embodiment as the fabric processing device 100 will be described with reference to FIG. 12. FIG. 12 is a diagram corresponding to FIG. 11 of the fabric processing device 100E according to the fifth embodiment. The fabric processing device 100F according to the embodiment is the same as the fabric processing devices 100 according to the first embodiment to the fifth embodiment except for the configuration described below. Therefore, the fabric processing device 100F according to the embodiment has the same features as those of the fabric processing devices 100 according to the first embodiment to the fifth embodiment except for the following description. Therefore, in FIG. 12, components common to those of the first embodiment to the fifth embodiment are denoted by the same reference numerals, and detailed description thereof will be omitted.

As shown in FIG. 11, in the fabric processing device 100E according to the fifth embodiment, the support unit 21C is disposed such that the flat surface portion 23b is substantially perpendicular to the ejecting direction B. On the other hand, as shown in FIG. 12, the support unit 21 according to the embodiment is provided such that the support unit 21C having the same shape as the support unit 21C according to the fifth embodiment has an angle θ2 of 45° with respect to the ejecting direction B of the flat surface portion 23b.

From another viewpoint, in the support surface 23 of the support unit 21C of the fabric processing device 100F according to the embodiment, the normal line N of the flat surface corresponding to the flat surface portion 23b forms an angle of 45° with respect to the horizontal plane. For the support surface 23 of the support unit 21C of the fabric processing device 100E according to the fifth embodiment, it can be expressed that the normal line N of the flat surface corresponding to the flat surface portion 23b forms an angle of 0° with respect to the horizontal plane. As described above, it is preferable that the normal line N of the flat surface corresponding to the flat surface portion 23b of the support surface 23 forms an angle of 0° or more and 45° or less with respect to the horizontal plane. With such a configuration, it is possible to prevent the liquid 3 ejected from the liquid ejecting unit 1 from dripping onto the liquid ejecting unit 1, and it is also possible to prevent the liquid 3 rebounding from the support surface 23 from adhering to the liquid ejecting unit 1, and thus it is possible to prevent the occurrence of ejecting failure in the liquid ejecting unit 1.

### Seventh Embodiment

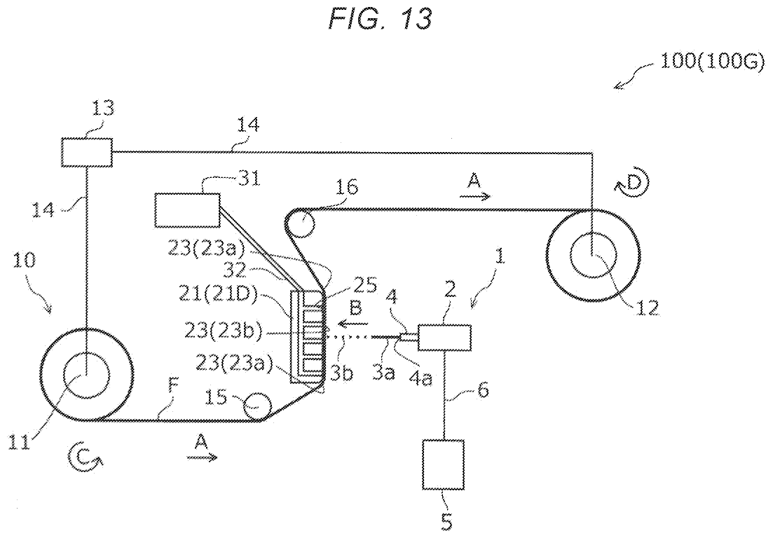

Hereinafter, a fabric processing device 100G according to a seventh embodiment as the fabric processing device 100 will be described with reference to FIG. 13. FIG. 13 is a diagram corresponding to FIG. 11 of the fabric processing device 100E according to the fifth embodiment. The fabric processing device 100G according to the embodiment is the same as the fabric processing devices 100 according to the first embodiment to the sixth embodiment except for the configuration described below. Therefore, the fabric processing device 100G according to the embodiment has the same features as those of the fabric processing devices 100 according to the first embodiment to the sixth embodiment except for the following description. Therefore, in FIG. 13, components common to those of the first embodiment to the sixth embodiment are denoted by the same reference numerals, and detailed description thereof will be omitted.

As shown in FIG. 13, the fabric processing device 100G according to the embodiment is different from the fabric processing device 100E according to the fifth embodiment in that a suction unit 31 to which a suction tube 32 is coupled is provided, and a plurality of suction holes coupled to the suction tube 32 are provided inside a support unit 21D having the same shape as the support unit 21C. In other words, the suction holes 25 are provided in the support unit 21D of the fabric processing device 100G according to the embodiment, and the fabric processing device 100G according to the embodiment includes the suction unit 31 that performs suction from the suction holes 25. Therefore, the fabric processing device 100G according to the embodiment can reliably support the fabric F on the support unit 21D by suctioning the fabric F through the suction holes 25, and it is possible to prevent a situation in which the liquid 3 is accumulated on the fabric F and a strong impact cannot be applied to the fabric F when the liquid 3 is suctioned through the suction holes 25.

An inner diameter of the suction hole 25 is preferably smaller than a diameter of the liquid droplet 3b. By making the inner diameter of the suction hole 25 smaller than the diameter of the liquid droplet 3b, it is possible to prevent a decrease in impact force when the liquid droplet 3b collides with the fabric F. A direction in which the suction hole 25 inside the support unit 21D extends is preferably shifted with respect to the ejecting direction B. This is because when the direction in which the suction hole 25 inside the support unit 21D extends is not shifted with respect to the ejecting direction B, the impact force when the liquid droplet 3b collides with the fabric F may decrease.

### Eighth Embodiment

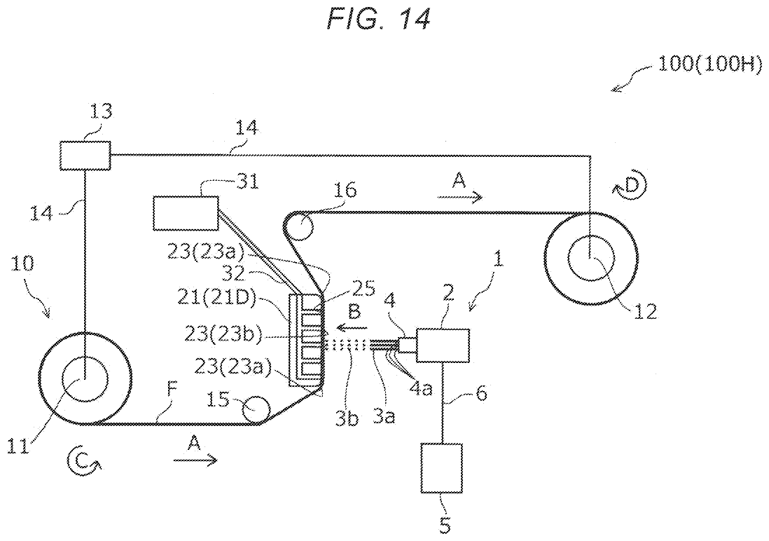

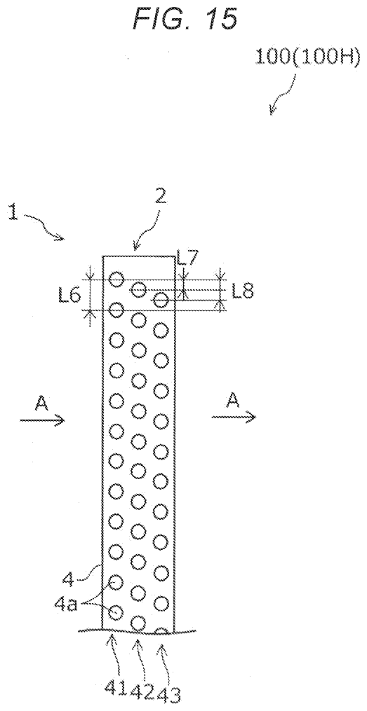

Hereinafter, a fabric processing device 100H according to an eighth embodiment as the fabric processing device 100 will be described with reference to FIGS. 14 and 15. Among them, FIG. 14 is a diagram corresponding to FIG. 13 of the fabric processing device 100G according to the seventh embodiment. FIG. 15 is a diagram corresponding to FIG. 8 of the fabric processing device 100C according to the third embodiment. The fabric processing device 100H according to the embodiment is the same as the fabric processing devices 100 according to the first embodiment to the seventh embodiment except for the configuration described below. Therefore, the fabric processing device 100H according to the embodiment has the same features as those of the fabric processing devices 100 according to the first embodiment to the seventh embodiment except for the following description. Therefore, in FIGS. 14 and 15, components common to those of the first embodiment to the seventh embodiment are denoted by the same reference numerals, and detailed description thereof will be omitted.

As shown in FIGS. 14 and 15, the fabric processing device 100H according to the embodiment has a plurality of ejecting port rows in which the ejecting ports 4a are arranged in the width direction intersecting the transport direction A, similarly to the fabric processing device 100C according to the third embodiment and the fabric processing device 100D according to the fourth embodiment. However, in the fabric processing device 100H according to the embodiment, unlike the fabric processing device 100C according to the third embodiment and the fabric processing device 100D according to the fourth embodiment, a total of three ejecting port rows 41, 42, and 43 are formed in one head unit 2.

As shown in FIG. 15, positions of the ejecting ports 4a of the ejecting port rows 41, 42, and 43 are shifted in the width direction. Specifically, an ejecting port pitch of each of the ejecting port row 41, the ejecting port row 42, and the ejecting port row 43 is a length L6, and the position of the ejecting port 4a of the ejecting port row 41 and the position of the ejecting port 4a of the ejecting port row 42 are shifted from each other by a length L7, which is ⅓ of the length L6, in the width direction. The position of the ejecting port 4a of the ejecting port row 41 and the position of the ejecting port 4a of the ejecting port row 43 are shifted from each other by a length L8, which is ⅔ of the length L6, in the width direction. With such a configuration, it is possible to narrow the ejecting port pitch of the entire device, and it is possible to particularly suitably improve the texture of the fabric F. By shifting the position of the ejecting port 4a in the transport direction A, there is also an effect of preventing a decrease in the effect of improving the texture of the fabric F due to the liquid 3 accumulating on the fabric F.

The present disclosure is not limited to the embodiments described above, and can be implemented in various configurations without departing from the scope of the disclosure. In order to solve a part or all of problems described above, or to achieve a part or all of effects described above, technical features in the embodiment corresponding to the technical features in each aspect described in the summary of the disclosure can be replaced or combined as appropriate. When the technical features are not described as essential in the present description, the technical features can be appropriately deleted.

What is claimed is:

1. A fabric processing device comprising:
a transport unit configured to transport a fabric in a transport direction;
a support unit configured to support the fabric; and
a liquid ejecting unit configured to eject a liquid onto the fabric supported by the support unit, wherein
the liquid ejecting unit is configured to eject the liquid in a continuous flow at an ejecting speed of 30 m/s or more, and the liquid ejected as the continuous flow is caused to collide with the fabric in a state of being liquid droplets to process the fabric.

2. The fabric processing device according to claim 1, wherein
the liquid ejecting unit is configured to eject the liquid in the continuous flow at an ejecting speed of 500 m/s or less.

3. The fabric processing device according to claim 1, wherein
the support unit has a support surface that supports the fabric, and
the liquid ejecting unit is disposed at a position facing the support surface.

4. The fabric processing device according to claim 3, wherein
the liquid ejecting unit is configured to eject the liquid in an ejecting direction forming an angle of 0° or more and 45° or less with respect to a normal line of the support surface.

5. The fabric processing device according to claim 4, wherein
the support surface is a convex curved surface protruding toward a liquid ejecting unit side.

6. The fabric processing device according to claim 4, wherein
the support surface is a flat surface.

7. The fabric processing device according to claim 6, wherein
the support surface has a normal line of the flat surface forming an angle of 0° or more and 45° or less with respect to a horizontal plane.

8. The fabric processing device according to claim 1, wherein
the liquid ejecting unit includes a nozzle having at least one ejecting port configured to eject the liquid, a liquid transport unit configured to transport the liquid to the ejecting port, and a pressurizing unit configured to pressurize the liquid in the liquid transport unit.

9. The fabric processing device according to claim 8, wherein
the ejecting port has a diameter of 0.005 mm or more and 0.12 mm or less.

10. The fabric processing device according to claim 8, wherein
the pressurizing unit has a pressurizing pressure of 0.5 MPa or more and 150 MPa or less.

11. The fabric processing device according to claim 1, further comprising:
a control unit configured to control an ejecting amount of the liquid ejected from the liquid ejecting unit.

12. The fabric processing device according to claim 1, wherein
the transport unit includes a driving roller configured to transport the fabric in the transport direction by rotating.

13. The fabric processing device according to claim 1, wherein
the support unit has a suction hole, and
the fabric processing device further includes a suction unit configured to perform suction from the suction hole.

14. The fabric processing device according to claim 2, wherein
the liquid ejecting unit includes a nozzle having at least one ejecting port configured to eject the liquid, a liquid transport unit configured to transport the liquid to the ejecting port, and a pressurizing unit configured to pressurize the liquid in the liquid transport unit.

15. The fabric processing device according to claim 14, wherein
the ejecting port has a diameter of 0.005 mm or more and 0.12 mm or less.

16. The fabric processing device according to claim 14, wherein
the pressurizing unit has a pressurizing pressure of 0.5 MPa or more and 150 MPa or less.

17. The fabric processing device according to claim 2, further comprising:
a control unit configured to control an ejecting amount of the liquid ejected from the liquid ejecting unit.

18. The fabric processing device according to claim 2, wherein
the transport unit includes a driving roller configured to transport the fabric in the transport direction by rotating.

19. The fabric processing device according to claim 2, wherein
the support unit has a suction hole, and
the fabric processing device further includes a suction unit configured to perform suction from the suction hole.
